(19) United States
(12) Patent Application Publication
(10) Pub. No.: US 2007/0094172 A1
(43) Pub. Date: Apr. 26, 2007

(54) Neural network based rating system

(76) Inventor: Stephen L. Thaler, St. Louis, MO (US)

Correspondence Address: HUSCH & EPPENBERGER, LLC, 190 CARONDELET PLAZA, SUITE 600, ST. LOUIS, MO, 63105-3441, US

(21) Appl. No.: 11/491,411

(22) Filed: Jul. 21, 2006

Related U.S. Application Data
(60) Provisional application No. 60/701,671, filed on Jul. 22, 2005.

(51) Int. Cl. G06F 15/18

(52) U.S. Cl. 706/16

(57) ABSTRACT

A neural network-based rating system includes a data set, said data set further comprising at least two records and at least one field associated with said records and a data rating application, which includes means for user input of ratings for at least a first of said records of said data set; at least one artificial neural network; means for automatically dimensioning said artificial neural network as a function of said fields within said data set; means for initiating training of said artificial neural network, said trained artificial neural network operative to generate ratings for at least a second of said records of said data set; means for initiating rating of at least said second record of said data set by said trained artificial neural network; and means for sorting said data set based on said user ratings and said artificial neural network-generated ratings.

### CROSS-REFERENCES

This application claims the priority of provisional application Ser. No. 60/701,671, filed Jul. 22, 2005.

### TECHNICAL FIELD OF THE INVENTION

This invention relates generally to the field of data analysis and, more particularly, to a neural network based system for rating records within a database.

### BACKGROUND OF THE INVENTION

Automatic rating or pattern identifying programs, while available, are generally quite limited in their applicability. Generally, prior art systems must be set up and programmed specifically for a particular application. In particular, these systems are generally designed to handle a set number fields that may be applicable to the records within a data set that is to be rated. While these systems may be modified and adapted to other data sets, such modification generally involves significant reprogramming of the system. While there are examples of rating systems that make use of conventional artificial neural networks, these ANN-based systems typically require extremely powerful processors to operate are still limited in their ability to dynamically size themselves, requiring assistance from human programmers. Furthermore, these ANN-based systems require a large number of pre-rated exemplary records for training and take a considerable amount of time to train.

Therefore, it would be advantageous to develop a rating/pattern identification system that is capable of dynamically sizing itself to adapt to multiple data sets and training in real time given a minimum of exemplary rated records. Furthermore, it would be advantageous if such a system was able to run on standard consumer computer systems.

The present invention is directed to overcoming one or more of the problems set forth above.

### SUMMARY OF THE INVENTION

One aspect of the invention generally pertains to a neural-network based system that allows users to rate records within a database according to any criteria while the system determines the pattern behind the user's preferences. The system is then able to rate and sort the remaining records in the database accordingly.

Another aspect of the invention pertains to a neural-network based system that is able to dynamically size itself to multiple data sets to be rated.

Yet another aspect of the invention pertains to a neural-network based system that requires only a minimum of exemplary records on which to train and is able to train in real time.

Another aspect of the invention pertains to a neural-network based system that is capable of operating on standard consumer computer systems.

In accordance with the above aspects of the invention, there is provided a neural network-based rating system that includes a data set, said data set further comprising at least two records and at least one field associated with said records and a data rating application, which includes means for user input of ratings for at least a first of said records of said data set; at least one artificial neural network; means for automatically dimensioning said artificial neural network as a function of said fields within said data set; means for initiating training of said artificial neural network, said trained artificial neural network operative to generate ratings for at least a second of said records of said data set; means for initiating rating of at least said second record of said data set by said trained artificial neural network; and means for sorting said data set based on said user ratings and said artificial neural network-generated ratings.

These aspects are merely illustrative of the innumerable aspects associated with the present invention and should not be deemed as limiting in any manner. These and other aspects, features and advantages of the present invention will become apparent from the following detailed description when taken in conjunction with the referenced drawings.

### BRIEF DESCRIPTION OF THE DRAWINGS

Reference is now made more particularly to the drawings, which illustrate the best presently known mode of carrying out the invention and wherein similar reference characters indicate the same parts throughout the views.

FIG. 1 is a diagrammatic view of a training technique associated with a neural network-based rating system according to an embodiment of the present invention.

FIG. 2 is a diagrammatic view of another training technique associated with a neural network-based rating system according to another embodiment.

FIG. 3 is a flow chart illustrating the general operation of a neural network-based rating system according to another embodiment.

FIG. 4 is a screen shot of a rated database using a neural network system according to an embodiment of the present invention.

FIG. 5 is a screen shot of a rated database using a neural network system according to another embodiment.

FIG. 6 is a diagrammatic view of a facial expression recognition system suitable for use with another embodiment of the present invention.

### DESCRIPTION OF THE PREFERRED EMBODIMENTS

In the following detailed description numerous specific details are set forth in order to provide a thorough understanding of the invention. However, it will be understood by those skilled in the art that the present invention may be practiced without these specific details. For example, the invention is not limited in scope to the particular type of industry application depicted in the figures. In other instances, well-known methods, procedures, and components have not been described in detail so as not to obscure the present invention.

The invention comprises an artificial neural network based tool that allows users to rate isolated records within a database according to any criteria, as the system “watches” and automatically gleans the pattern behind the user's preferences that are registered through simple mouse clicks. Thereafter, the system rates and sorts all the records in the database from most to least desirable. This application can serve myriad roles, ranging from targeted mailing, employee reviews, modus operandi, to computer dating applications.

Product Features
mouse-driven ranking of individual database records
records and fields limited only by computer memory
extremely rapid training of the underlying neural network engine
ability not only to sort by preference, but upon all other attributes

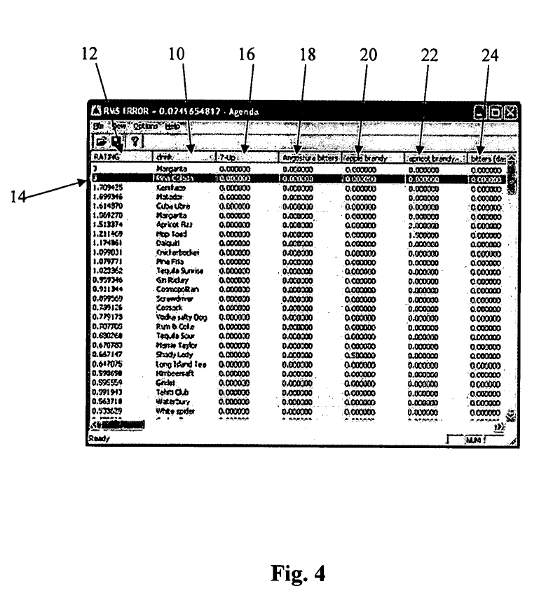

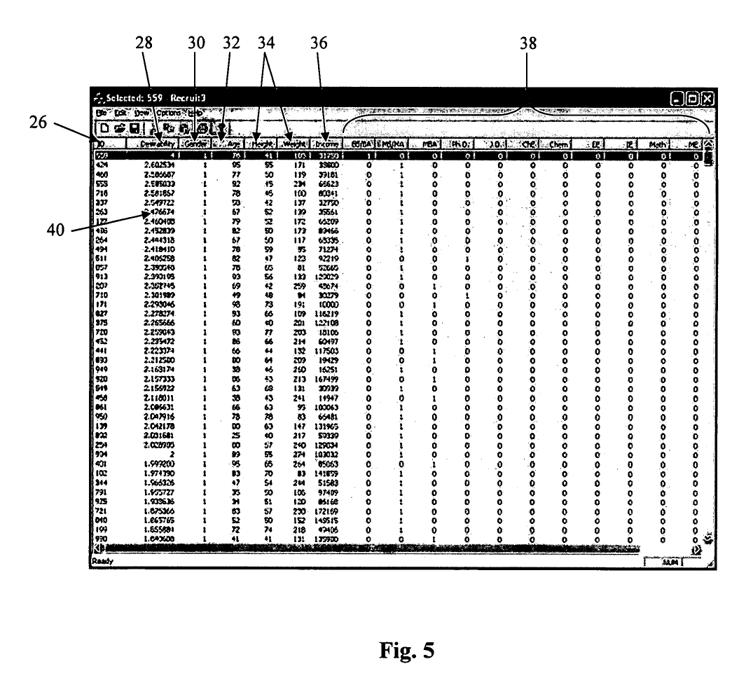

In one embodiment of the system, as illustrated in the screen shots of FIGS. 4-5, a user opens a text file containing a database. Each record (listed in the second column) appearing within the grid control will contain some identifier. In FIG. 4, the identifier is the name of a drink contained in column 10. In FIG. 5, the identifier is an ID code for a job candidate in column 26. A series of fields relating to numerical attributes (i.e., age, gender, education, zip code, etc.) is associated with each identifier. In the embodiment of FIG. 4, these attributes comprise the proportion of ingredients in the identified drink as listed in columns 16-24. In FIG. 5, these attributes include aspects such as gender (30), age (32), physical characteristics like height and weight (34), current income level (36), educational history (38).

The user begins the rating process by simply left clicking a number of times on any record to indicate his or her satisfaction with it, or right click in proportion to their dissatisfaction with any database entry. Once several exemplary records (i.e., number of units of a product sold to that customer in the previous year) have been ranked, the user selects “Learn” from the “Options” menu. The system now develops a model of how the attribute fields of the database relate to the user's selection criteria. Thereafter, the user selects “Rate” from the Options menu to supply projected rankings for all the remaining entries in the database. In FIGS. 4 and 5, the user may instead simply click the “Rating” (12) or “Desirability” (28) column header to produce the projected ratings. By simply pressing the Desirability column header, the entire database will be ranked from most to least desirable. Repeatedly toggling on this column header will alternate the record order from descending to ascending order or preference. A numerical value (14, 40) is assigned to each record within the database that was not previously ranked by the user prior to the “Learn” stage.

In the preferred embodiment, a Self-Training Artificial Neural Network Object (“STANNO”) lies at the heart of the system. STANNOs are the subject of and are described in detail in U.S. Pat. No. 6,014,653, the entire disclosure of which is hereby expressly incorporated by reference herein. In alternate embodiments, it is possible to utilize versions of the applicant's Creativity Machines as described in U.S. Pat. No. 5,659,666 and its derivative patents. U.S. Pat. Nos. 5,845,271, 5,852,815, 5,852,816, 6,018,727, 6,115,701, 6,356,884, the entire disclosures of which are all expressly incorporated by reference herein.

One key benefit of these STANNOs are their ability to dynamically size themselves to correspond to the relevant fields associated with the records within the database and to automatically construct their internal connection weights based on the training rating pattern provided by the user's inputting of a few exemplary ratings. This feature ensures that a single system is able to accommodate and adapt to multiple databases of any dimension and layout rather than being limited to dedicated use with a particular database.

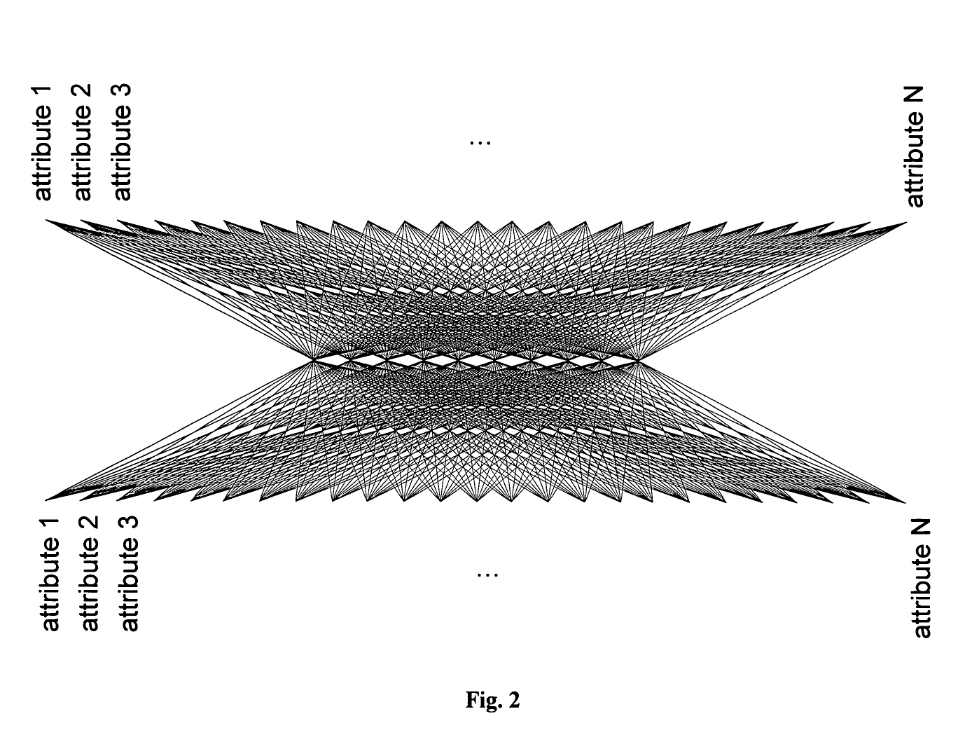

The STANNO used in the system may be one of two types: auto- and hetero-associative, multilayer perceptrons intercommunicating with one another. An auto-associative network, see FIG. 2, has the same number of input and output units. Training of an auto-associative network involves at least one cycle of propagating an input pattern through the network, while using that same pattern as the target output pattern for the backpropagation step. Over sufficient feed forward and backpropagation cycles, the network learns to replicate this, as well as other similarly reinforced patterns, at its output layer. Later, the assessment as to whether an arbitrary input pattern is one of such memories depends upon its reconstruction error through the network, typically determined by the Euclidean distance between the input and output patterns. Similarly, a memory can be reconstructed through the application of some stochastically generated seed pattern at the input layer, followed by multiple recursions between the output and input layer, so that the input and output patterns converge toward one another. Any such resulting pattern that remains stable throughout this recurrence is then said to constitute a memory of the auto-associative network.

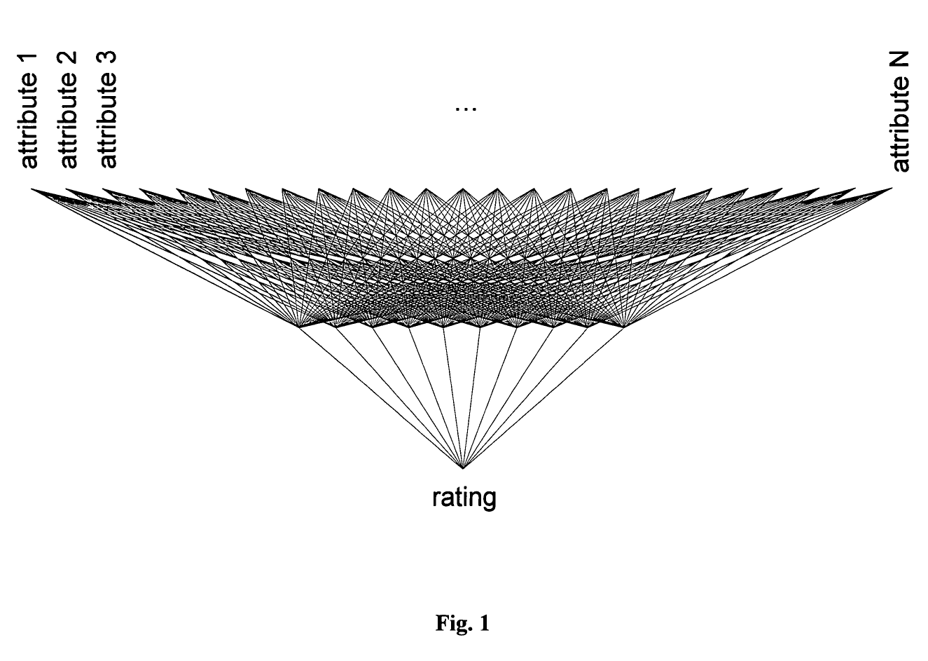

The hetero-associative network, see FIG. 1, is one mapping one vector space to another, typically resulting in a neural network having different numbers of input and output units. In training a hetero-associative network, the objective is not to absorb a memory into the network, but to impress some typically nontrivial input-output relationship across it.

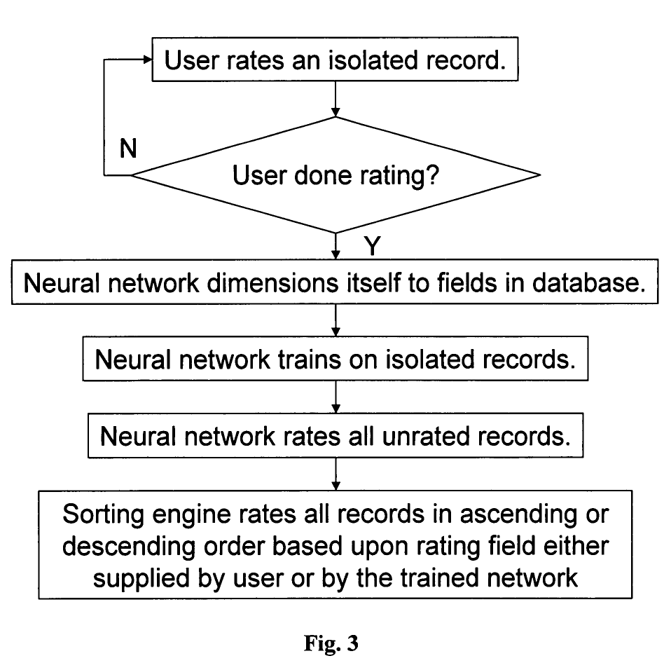

The general operation algorithm of a system as described herein is illustrated by the flowchart of FIG. 3. The initial step (30) is for a user to input a rating for at least one record in the database. Of course, a greater the number of exemplary ratings input by the user results in more accurate training data for the system, which will generally produce faster training. Once the user is finished inputting exemplary ratings (32), the underlying artificial neural network dimensions itself based on the fields associated with the records of the database. The network then trains (34) on the records for which the user has entered ratings. Once the network has finished training, it then rates the remaining records of the database (36) and, finally, sorts all of the records of the database (38) according to their associated rating, whether entered by the user or generated by the network. The network can go through each of these steps sequentially, or it may begin dimensioning and training while the user is inputting exemplary ratings. Furthermore, initiation of the training, rating, and sorting steps can occur automatically once the previous step has been completed or upon an indication by the user to move to the next step (e.g., clicking on “Learn”, “Rate”, and “Sort” buttons on the screen).

In one embodiment utilizing an auto-associative network, the concept of a “group membership filter” may be incorporated. A group membership filter is defined herein as an auto-associative, multilayer perceptron that has been trained on a body of patterns representing some genre, such as a recognized rating pattern for a given set of data.

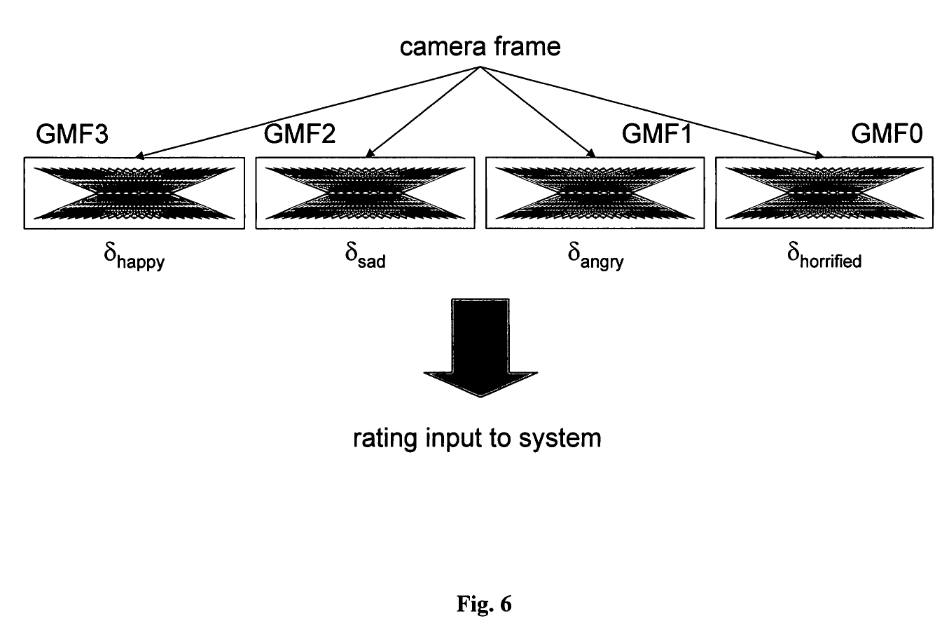

In the embodiment illustrated in FIGS. 4-7, the system is displayed to a user in spreadsheet-style format using a series of columns and rows. In the illustrated embodiments, the first column contains the ratings for each record in the data set, which are contained in the second column. Initially, the ratings for all records are set at 0. In the third, fourth, and subsequent columns (as needed), fields representative of particular, numerically-conveyed, characteristics associated with each record are displayed. The system can accommodate practically any number of fields.

Other information display options are used in alternate embodiments. In one embodiment, a graphical representation of an object associated with the records of the database is use. For example, for a database in which the records relate to room types and sizes for a residence, the display may take the form of a house floor plan. In another embodiment, the system generates a sensory response, e.g., a tactile sensation (heat, cold, vibration, smell), that is associated with a particular record through the incorporation of known and widely used machinery.

The system is also compatible with various data input devices through which a user may register their level of satisfaction or dissatisfaction, i.e., rating, of the records in the database. One of the simpler such devices is by clicking on a standard mouse button on each record within a database laid out in the manner illustrated in FIGS. 4-7 in order to raise or lower a numerical rating for that record. Alternate data entry devices, such as a computer keyboard or tablet may be used in a similar manner. More advanced rating input devices include biometric sensors intended to record key biometric data of user being exposed to particular records. For example, a user's blood pressure or pulse rate might be taken as the user is shown a series of records, with the blood pressure or pulse rate being indicative of the user's anxiety or relaxation upon such exposure.

A video camera employing known facial expression recognition technology may be used to ascertain the user's emotions upon viewing each record. The technique uses multiple networks operating as group membership filters operating in parallel, each trained to classify an emotion, as expressed through facial gestures. In other words the losing networks disqualify themselves based upon their non-recognition of the emotional genre. The network/group membership filter registering the least anomaly is the one “claiming” the facial expression. This type of parallel operation of networks operating as group membership filters is described in detail in U.S. Pat. Nos. 5,852,816 and 5,852,815, the disclosures of which are expressly incorporated by reference herein.

In another embodiment of the system, the neural network and the controls for the system, i.e., trigger for training of the network, trigger for initiating rating of the remaining records in the database, and trigger for sorting the rated records, are integrated within the system. The triggers for these various steps in the system procedure may take any number of standard forms know to those of skill in the art. Examples include buttons within a graphical user interface, as illustrated in the embodiments of FIGS. 4 and 5, and programming within the system that triggers these steps automatically following a user's first input of a rating and following completion of the immediately preceding step. It is not necessary for the data set to be integrated within the system. The system can access a data set located on a remote server or other system via known communication links, such as the Internet, wide area networks, or local area networks.

In a preferred embodiment, the invention is incorporated in a Windows application designed to run in Windows 2000 or XP operating systems. However, those of skill in the art will recognize that the invention may be readily adopted for use on any known operating system platform.

Security measures, such as the requirement for a user to possess a security dongle or requiring entry of a password, may be incorporated into embodiments of the invention.

While the invention is not limited to the following specific applications, they are exemplary of the uses of different embodiments of the present invention:
Rate a client database from most to least likely to buy products or services, based upon their demographics.
Rank employees from most to least deserving of raises and promotions, based upon various performance metrics.
Rank criminal databases from most to least likely to perpetrate a crime based upon their personal attributes.
Let a computer dating applicant register their affinities for several other members in your database and then rank the entire database from most to least desirable to them.
Use as a party game as others guess your hidden agenda in ranking the other attendees.
Use pre-trained neural network modules to rank databases

The preferred embodiments of the invention have been described above to explain the principles of the invention and its practical application to thereby enable others skilled in the art to utilize the invention in the best mode known to the inventors. However, as various modifications could be made in the constructions and methods herein described and illustrated without departing from the scope of the invention, it is intended that all matter contained in the foregoing description or shown in the accompanying drawings shall be interpreted as illustrative rather than limiting. Thus, the breadth and scope of the present invention should not be limited by the above-described exemplary embodiment, but should be defined only in accordance with the following claims appended hereto and their equivalents.

I claim:

1. A neural network-based rating system, comprising:
a data set, said data set further comprising at least two records and at least one field associated with said records;
a data rating application, further comprising:
means for user input of ratings for at least a first of said records of said data set;
at least one artificial neural network;
means for automatically dimensioning said artificial neural network as a function of said fields within said data set;
means for initiating training of said artificial neural network, said trained artificial neural network operative to generate ratings for at least a second of said records of said data set;
means for initiating rating of at least said second record of said data set by said trained artificial neural network; and
means for sorting said data set based on said user ratings and said artificial neural network-generated ratings.

2. The neural network-based rating system of claim 1, wherein said data set is integrated with said data rating application.

3. The neural network-based rating system of claim 1, further comprising a communication link between said data set and said data rating application and wherein said data set and said data rating application reside on first and second remote computer, respectively.

4. The neural network-based rating system of claim 3, wherein said communication link is selected from the group consisting of the Internet, a wide area network, and a local area network.

5. The neural network-based rating system of claim 1, wherein said system further comprises a graphical user interface.

6. The neural network-based rating system of claim 5, wherein said graphical user interface comprises a spreadsheet-type screen comprising a grid representing said records and said field.

7. The neural network-based rating system of claim 5, wherein said graphical user interface comprises a depiction of an object associated with said records of said data set.

8. The neural network-based rating system of claim 1, wherein said artificial neural network comprises at least one hetero-associative network.

9. The neural network-based rating system of claim 1, wherein said artificial neural network comprises at least one auto-associative network.

10. The neural network-based rating system of claim 1, wherein said means for initiating training of said artificial neural network operates as ratings are entered via said user interface.

11. The neural network-based rating system of claim 1, wherein said means for initiating training of said at least one neural network operates automatically upon user input of ratings for said at least first record.

12. The neural network-based rating system of claim 1, wherein said means for initiating rating of said second portion of said data set by said trained artificial neural network automatically initiates rating once said artificial neural network is trained.

13. The neural network-based rating system of claim 1, wherein said means for sorting said data set by said ratings generated by said artificial neural network automatically initiates sorting once said artificial neural network is trained and finishes rating said second portion of said data set.

14. The neural network-based rating system of claim 1, wherein said user input means is selected from the group consisting of a mouse, a keyboard, and a tablet device.

15. The neural network-based rating system of claim 1, wherein said user input means comprises a sensor.

16. The neural network-based rating system of claim 15, wherein said sensor is a biometric sensor.

17. The neural network-based rating system of claim 1, wherein said user input means comprises a speech recognition system.

18. The neural network-based rating system of claim 1, wherein said user input means comprises a video camera.

19. The neural network-based rating system of claim 18, wherein said user input means further comprises a facial recognition system.

20. The neural network-based rating system of claim 1, wherein said artificial neural network comprises a group membership filter.

21. A neural network based rating process, comprising the steps of:
providing a data set, said data set comprising at least two records and at least one field associated with said records;
inputting ratings for at least one of said records;
providing at least one artificial neural network which is integrated into a single executable file associated with said rating process;
automatically dimensioning said artificial neural network as a function of said fields associated with said data set;
training said dimensioned artificial neural network based on said at least one rating input;
rating at least one unrated record within said data set; and
sorting said records of said data set based on said input ratings and ratings generated by said artificial neural network.

22. The neural network-based rating process of claim 21, wherein said step of inputting ratings further comprises a user indicating a rating by manipulating a data entry device.

23. The neural network-based rating process of claim 21, wherein said step of inputting ratings further comprises sensing a user's degree of satisfaction via a sensor.

24. The neural network-based rating process of claim 21, wherein said step of providing at least one artificial neural network further comprises providing an auto-associative artificial neural network.

25. The neural network-based rating process of claim 21, wherein said step of providing at least one artificial neural network further comprises providing a hetero-associative artificial neural network.

26. The neural network-based rating process of claim 21, further comprising the step of displaying said data set to a user and wherein said step of sorting said records further comprises displaying said sorted records to said user.

27. The neural network-based rating process of claim 26, wherein said step of displaying said data set to said user further comprises producing a spreadsheet-type screen comprising a grid representing said records and said field.

28. The neural network-based rating process of claim 26, wherein said step of displaying said data set to said user further comprises producing a depiction of an object associated with said records of said data set.

29. The neural network-based rating process of claim 26, wherein said step of displaying said data set to said user further comprises producing a sensation associated with said records of said data set.
